(19) United States
(12) Patent Application Publication
(10) Pub. No.: US 2003/0122637 A1
(43) Pub. Date: Jul. 3, 2003

(54) High quality factor inductor

(75) Inventor: Chien-Chih Chiu, Dali City (TW)

Correspondence Address: Richard P. Berg, Esq., c/o LADAS & PARRY, Suite 2100, 5670 Wilshire Boulevard, Los Angeles, CA, 90036-5679, US

(73) Assignee: DARFON ELECTRONICS CORP.

(21) Appl. No.: 10/313,098

(22) Filed: Dec. 5, 2002

(30) Foreign Application Priority Data
Dec. 31, 2001 (TW) 90133438

(51) Int. Cl. H01P 3/08

(52) U.S. Cl. 333/238; 333/246

(57) ABSTRACT

A microstrip inductor with a high quality factor. The inductor includes a substrate, a ground plane, a microstrip line, and a shielding conductor. The shielding conductor may be a surface conductor or a buried conductor. The substrate has an upper surface and a lower surface. The ground plane is disposed on the lower surface of the substrate and is coupled to a ground potential. The microstrip line is disposed on the upper surface of the substrate. The surface conductor is disposed on the upper surface of the substrate and is located at a gap of a length from the microstrip line and is coupled to the ground potential. The buried conductor is disposed within the substrate and is located at a gap of a length from the microstrip line and is punched through the substrate to couple to the ground potential.

### BACKGROUND OF THE INVENTION

1. Field of the Invention

The present invention relates to a high quality factor inductor, and particularly to an inductor made of microstrip lines which are applied to a voltage control oscillator.

2. Description of the Related Art

Phase noise is a very important parameter in designing voltage control oscillators. Phase noise dominates interference with adjacent channels. Sources of phase noise include flicker noise from active device, shot noise, and thermal noise. All of these noise sources modulate the signal generated by voltage control oscillator. The quality factor of passive device determines the bandwidth of voltage control oscillator, i.e., determines the noise spectrum around the center frequency of the voltage control oscillator. By Leeson's model, increasing quality factor of passive devices is a method to reduce phase noise. Thus, LC tank is usually feasible for the requirements of the wireless communication.

FIG. 1 shows the conventional Clapp voltage control oscillator. The active device includes a bipolar junction transistor T1 in common collector configuration. The resonance circuit, determining the oscillator frequency and the quality factor of the voltage control oscillator, includes capacitor C1, capacitor C2, capacitor C3 and a microstrip inductor L1. The resistor R3 and varactor Cv in series are used for tuning the oscillator frequency. A tuning voltage is applied to the cathode of the varactor Cv via resistor R3. The junction of the resistor R1 and the resistor R2 provide a bias for the bipolar junction transistor T1. The bipolar junction transistor T1 associates with the capacitor C1 and the capacitor C2 to provides a sufficient negative impedance at the base of the bipolar junction transistor T1 to cancel the resistance loss and generate stable oscillation.

A switch voltage Vc applied to the diode D1 via a resistor R4 is for shorting some portion of the inductor L1. Thus, the oscillation frequency of the resonance circuit is shifted to an upper band, i.e. the diode D1 is for switching over oscillation frequency. The switch voltage Vc is DC voltage, so a blocking capacitor C5 is required. The capacitance and the tolerance of the capacitor C5 contribute some deviation to the oscillation frequency, but the capacitor C5 couples to a low impedance node such that the quality factor of the capacitor C5 has less of an effect on the operation of the resonance circuit. When the switch voltage Vc is high, the capacitor C5 still conducts some current such that the diode D1 is forward biased. The last capacitor C5 ceases conduction and the diode D1 is reverse biased. The branch containing capacitor C5 and the diode D1 is effectively removed.

The inductor L1 may be accomplished by a tapped coil or preferably, a microstrip line or combination of both types. Shorting a portion of a coil will introduce parasitic resonance into the circuit. If too much of the coil is shorted, the quality factor of the coil is lowered, as the shorted and the unshorted portions are located on the same core. The tapped inductor L2 is in the position as shown in FIG. 2, even when a portion of the tapped inductor L2 is bypassed, the bypassed portion will acts as an antenna picking up extraneous signals. Since both bypassed and non bypassed portion are on the same core, mutual coupling causes noise picked up on one portion to be coupled to the other.

The quality factor of the microstrip inductor L1 is higher than that of the tapped coil L1, so the microstrip inductor L1 is more suitable for a resonance device of a voltage control oscillator. The microstrip inductor L1 is a transmission-line with a single conductor trace on one side of a dielectric substrate and a single ground plane on the opposite side. Since it is an open structure, the microstrip inductor L1 has a major fabrication advantage. It also features ease of interconnection and adjustment. Therefore, the microstrip inductor L1 is directly laid out on a printed circuit board. As shown in FIG. 3, the microstrip inductor L1 is coupled to a ground plane 50 by a through hole. Further, the microstrip inductor L1 is typically of high accuracy and repeatability, which reduces tolerance and yield related problems during manufacture.

There are three types of losses that occur in microstrip inductor L1: conductor (or ohmic) losses, dielectric losses, and radiation losses. Conductor losses are a result of microstrip and ground planes having finite conductivity. There is a non-uniform current density starting at the surface and exponentially decaying into the bulk of the conductive metal. When the frequency of the signal transmitted on the microstrip inductor L1 is higher, the skin depth of the microstrip inductor is thinner. Thus, the equivalent resistance of the conductor los is higher. The dielectric losses come from the loss tangent of the substrate. Usually high dielectric constant substrate has a higher loss tangent. Semi-open geometry structure of the microstrip inductor has an advantage of ease fabrication, but has a disadvantage of acting as an antenna and radiating energy. The use of high-dielectric-constant substrate reduce radiation losses because most of the EM field is concentrated in the dielectric between the microstrip inductor and the ground plane. The other benefit is that the circuit's package is decreased for the shorter wavelength in the high-dielectric substrate, but the high-dielectric-constant substrate materials are more expensive. Substrate with low dielectric constant is used when cost reduction is the priority. However, the lower the dielectric constant, the less the concentration of energy is in the substrate region and, hence, the more are the radiation losses. As shown in FIG. 4, the electric field in the substrate between the microstrip inductor L1 and the ground plane 50 is more concentrated, and the electric field lines near the edges of the microstrip inductor L1 are more diverged, a few fringing electric field lines occur in the air, i.e., some energy is radiated into the air. In order to reduce radiation losses, disposing some conductor besides the microstrip inductor is necessary.

### SUMMARY OF THE INVENTION

It is therefore an object of the present invention to provide an inductor having a high quality factor.

To achieve the above objects, the present invention provides a mocrostrip inductor. According to the embodiment of the invention, the microstrip inductor includes a substrate, a ground plane, a microstrip line, and a surface conductor. The substrate has an upper surface and a lower surface. The ground plane is disposed on the lower surface of the substrate and is coupled to a ground potential. The microstrip line is disposed on the upper surface of the substrate. The surface conductor is disposed on the upper surface of the substrate and is located at a gap of a length from the microstrip line and is coupled to the ground potential.

The present invention provides another mocrostrip inductor. According to the embodiment of the invention, the microstrip inductor includes a substrate, a ground plane, a microstrip line, and a buried conductor. The substrate has an upper surface and a lower surface. The ground plane is disposed on the lower surface of the substrate and is coupled to a ground potential. The microstrip line is disposed on the upper surface of the substrate. The buried conductor is disposed within the substrate and is located at a gap of a length from the microstrip line and is punched through the substrate to couple to the ground potential.

### BRIEF DESCRIPTION OF THE DRAWINGS

The aforementioned objects, features and advantages of this invention will become apparent by referring to the following detailed description of the preferred embodiment with reference to the accompanying drawings, wherein:

FIG. 1 shows the conventional Clapp voltage control oscillator;

FIG. 2 shows a schematic diagram of a resonance circuit;

FIG. 3 shows a printed circuit board structure of a conventional Clapp voltage control oscillator;

FIG. 4 shows a stereogram of a conventional microstrip line;

FIGS. 5-6 show cross-sectional diagrams according to the embodiments of the present invention;

FIGS. 7-8 shows stereograms according to the embodiments of the present invention;

FIG. 9 shows a layout according to the embodiments of the present invention.

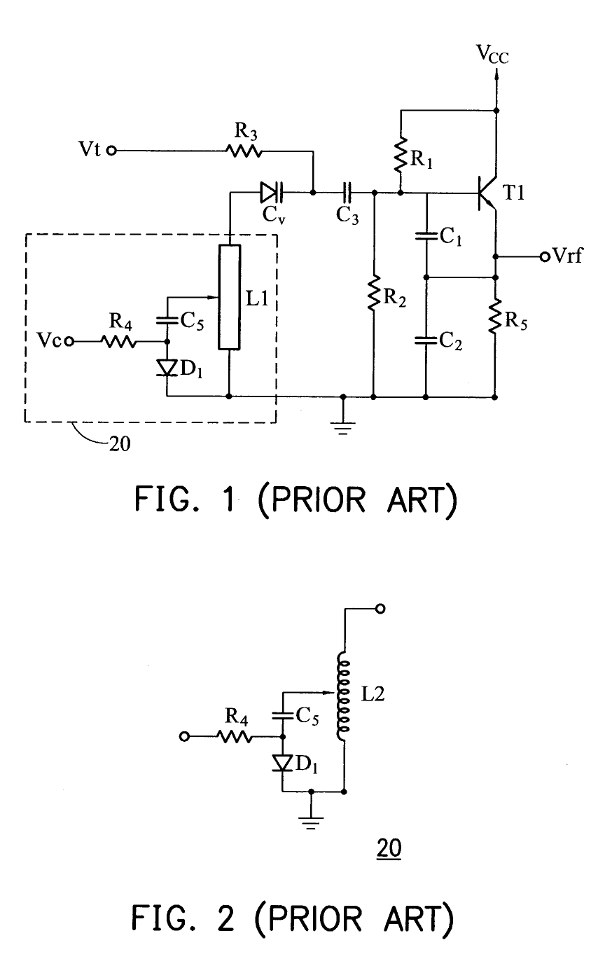

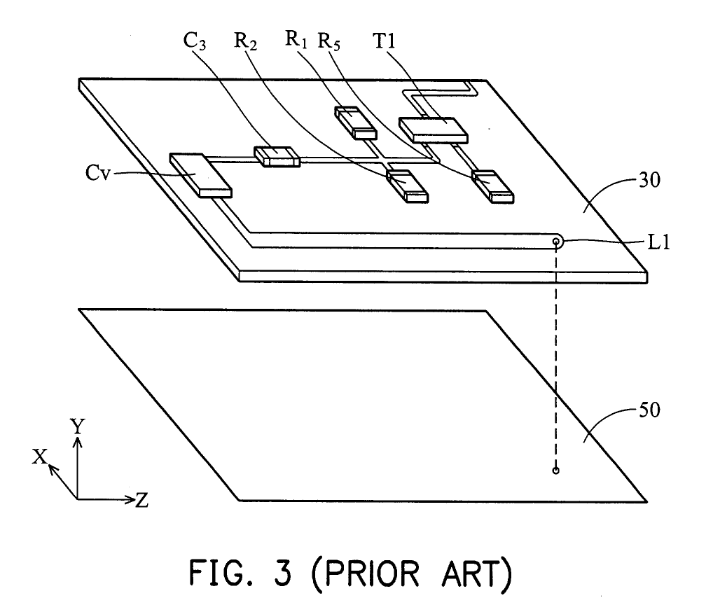

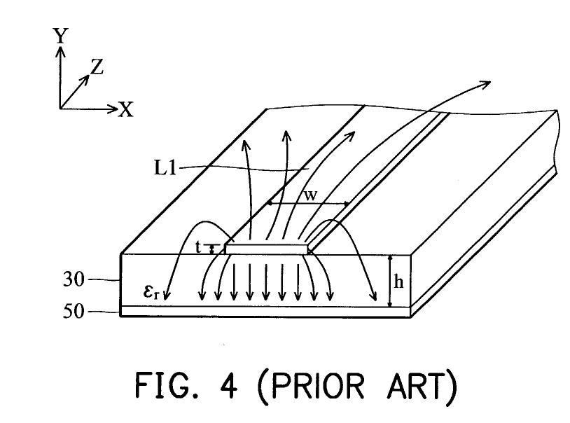

### DETAILED DESCRIPTION OF THE PREFERRED EMBODIMENT

To reduce radiation losses of the microstrip inductor, some conductor are disposed in parallel to the microstrip inductor for less fringing effect and less radiation energy in the air.

The First Embodiment

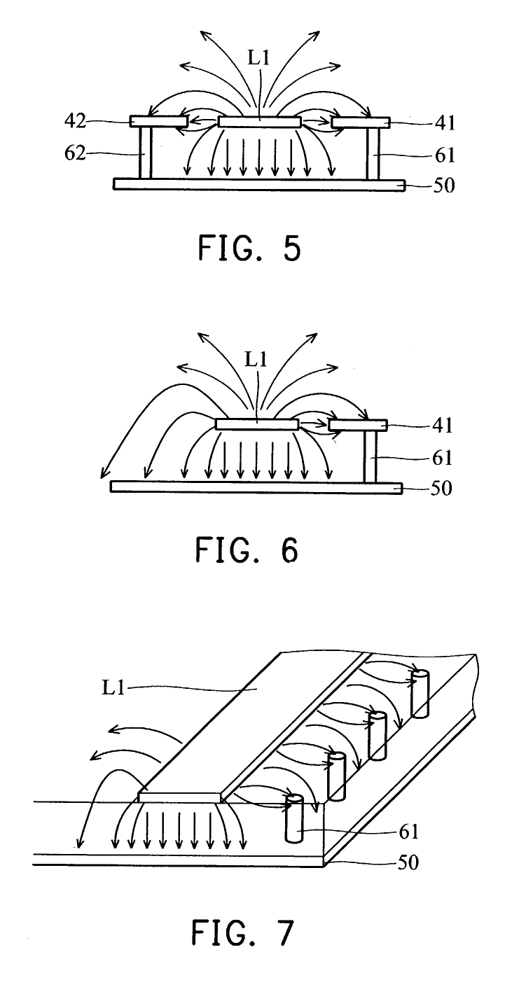

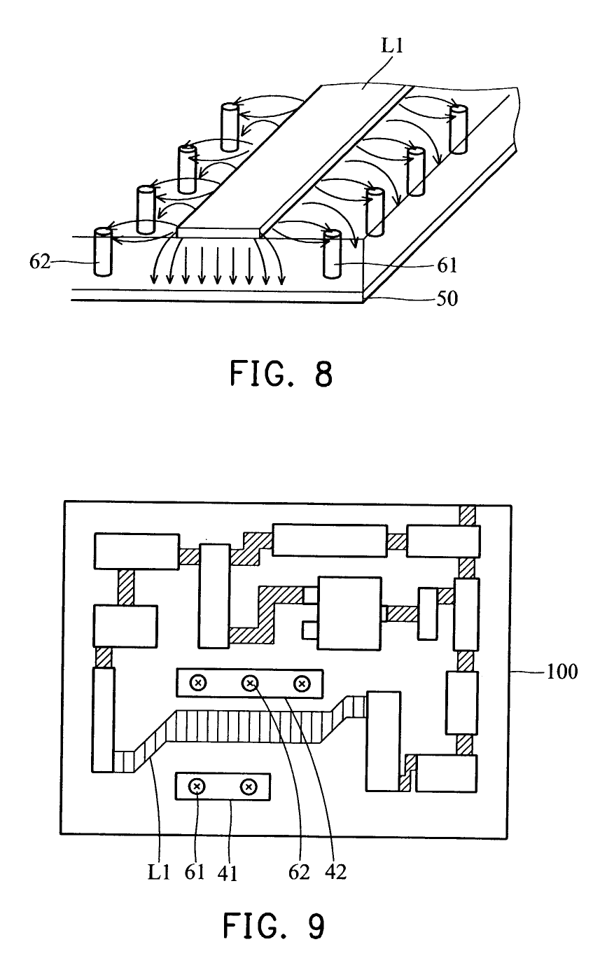

FIG. 5 shows the cross section of the microstrip inductor. The microstrip structure includes the microstrip inductor L1, the ground plane 50, ground strip conductor 41, ground strip conductor 42, plug conductor 61, and plug conductor 62. The ground strip conductor 41, coupled to the ground plane 50 by the plug conductor 61, is located at one side of the microstrip inductor L1 and is parallel to the microstrip inductor L1. A gap between microstrip inductor L1 and ground strip has a length D which is smaller than 3 mm. The ground strip conductor 42, coupled to the ground plane 50 by the plug conductor 62, is located at the other side of the microstrip inductor L1 and is parallel to the microstrip inductor L1. The quasi-static electric field lines of the two sides of the microstrip inductor L1 are concentrated in the region near the ground strip conductor 41 and 42. Thus, less energy radiates into the air, so the radiation losses of the microstrip inductor L1 are reduced and the quality factor is raised.

FIG. 9 shows the layout diagram of a voltage control oscillator. The ground strip conductor 41 and 42 are respectively parallel to the microstrip inductor L1

The Second Embodiment

FIG. 6 shows the cross section of the microstrip inductor. The microstrip structure includes the microstrip inductor L1, the ground plane 50, ground strip conductor 41, and plug conductor 61. The ground strip conductor 41, coupled to the ground plane 50 by the plug conductor 61, is located at one sides of the microstrip inductor L1 and is parallel to the microstrip inductor L1. The quasi-static electric field lines of one sides of the microstrip inductor L1 are concentrated in the region near the ground strip conductor 41. Thus, less energy radiates into the air, so the radiation losses of the microstrip inductor L1 are reduced and the quality factor is raised.

The Third Embodiment

FIG. 7 shows the cross section of the microstrip inductor. The microstrip structure includes the microstrip inductor L1, the ground plane 50, and an array of plug conductors 61. The array of plug conductor 61 is located at one side of the microstrip inductor L1 and is parallel to the microstrip inductor L1. The quasi-static electric field lines of one sides of the microstrip inductor L1 are concentrated in the region near the array of plug conductors 61. Thus, less energy radiates into the air, so the radiation losses of the microstrip inductor L1 are reduced and the quality factor is raised.

The Fourth Embodiment

FIG. 7 shows the cross section of the microstrip inductor. The microstrip structure includes the microstrip inductor L1, the ground plane 50, and an array of plug conductors 61 and 62. The array of plug conductor 61 is located at one side of the microstrip inductor L1 and is parallel to the microstrip inductor L1. The array of plug conductor 62 is located at the other side of the microstrip inductor L1 and is parallel to the microstrip inductor L1. The quasi-static electric field lines of one side of the microstrip inductor L1 are concentrated in the region near the array of plug conductors 61 and 62. Thus, less energy radiates into the air, so the radiation losses of the microstrip inductor L1 are reduced and the quality factor is raised.

Although the present invention has been described in its preferred embodiment, it is not intended to limit the invention to the precise embodiment disclosed herein. Those who are skilled in this technology can still make various alterations and modifications without departing from the scope and spirit of this invention. Therefore, the scope of the present invention shall be defined and protected by the following claims and their equivalents.

What is claimed is:

1. An inductor structure, comprising:
a substrate having an upper surface and a lower surface;
a ground plane disposed on the lower surface of the substrate and coupled to a ground potential;
a microstrip line disposed on the upper surface of the substrate; and
a surface conductor disposed on the upper surface of the substrate, located at a gap of a length D from the microstrip line and coupled to the ground potential; wherein the length D is smaller than 3 mm.

2. The inductor structure as claimed in claim 1 wherein a longitudinal axis of the microstrip line is along a first direction and the surface conductor is substantially along the first direction.

3. The inductor structure as claimed in claim 1 wherein the surface conductor is a strip conductor disposed on the upper surface of the substrate and near a side of a longitudinal axis of the microstrip line.

4. The inductor structure as claimed in claim 1 wherein the surface conductors comprise:
a first strip conductor disposed on the upper surface of the substrate and near a first side of a longitudinal axis of the microstrip line; and
a second strip conductor disposed on the upper surface of the substrate and near a second side of the longitudinal axe of the microstrip line.

5. The inductor structure as claimed in claim 1 further comprising
a plug conductor punched through the substrate and coupled between the surface conductor and the ground plane.

6. The inductor structure as claimed in claim 4 further comprising
a first plug conductor punched through the substrate and coupled between the first strip conductor and the ground plane; and
a second plug conductor punched through the substrate and coupled between the second conductor and the ground plane.

7. The inductor structure as claimed in claim 4 further comprising
a first plug array punched through the substrate and coupled between the first strip conductor and the ground plane; and
a second plug array punched through the substrate and coupled between the second conductor and the ground plane; wherein a longitudinal axis of the microstrip line is along a first direction, and the surface conductor, the first strip conductor, and the second strip conductor are substantially along the first direction.

8. An inductor structure, comprising:
a substrate having an upper surface and a lower surface;
a ground plane disposed on the lower surface of the substrate and coupled to a ground potential;
a microstrip line disposed on the upper surface of the substrate; and
a buried conductor disposed within the substrate, located at a gap of a length D from the microstrip line and coupled to the ground potential; wherein the length D is smaller than 3 mm.

9. The inductor structure as claimed in claim 8 wherein a longitudinal axis of the microstrip line is along a first direction and the buried conductors are substantially along the first direction.

10. The inductor structure as claimed in claim 8 wherein a longitudinal axis of the microstrip line is along a first direction and the buried conductor comprise plural plug conductors which are substantially along the first direction.

11. The inductor structure as claimed in claim 10 wherein the plural plug conductors comprise:
a first plug array disposed on a first side of the microstrip line; and
a second plug array disposed on the second side of the microstrip line.
